(19) United States
(12) Patent Application Publication
(10) Pub. No.: US 2019/0325410 A1
(43) Pub. Date: Oct. 24, 2019

(54) METHODS AND SYSTEM FOR SELECTING PAYMENT SYSTEM FOR TRANSACTION ROUTING

(71) Applicant: Mastercard International Incorporated, Purchase, NY (US)

(72) Inventors: Mostafa Hussein Sabet, Greenwich, CT (US); Mohammed Kamal, Paramus, NJ (US)

(21) Appl. No.: 15/958,762

(22) Filed: Apr. 20, 2018

(51) Int. Cl. G06Q 20/10

(52) U.S. Cl. CPC G06Q 20/10

(57) ABSTRACT

A method includes receiving a request for a payment transaction. The requested transaction may have a number of attributes. A particular transaction routing option may be selected from among two or more transaction routing options. The selection may be based at least in part on the attributes of the requested transaction. The two or more transaction routing options may include at least one ACH (automated clearing house) system and at least one payment card account system. The transaction may be executed via the selected transaction routing option.

### BACKGROUND

A number of different types of funds transfer systems exist or have been proposed. For example, ACH (automated clearing house) systems exist for transferring funds from a sender's bank account to a recipient's bank account. It is also known to utilize a payment card network as the “backbone” of a system for account-to-account funds transfers.

The present inventors have now recognized opportunities for simplifying account-to-account funds transfer procedures and making them more efficient and cost effective, particularly from the point of view of originating depository financial institutions (ODFIs).

### BRIEF DESCRIPTION OF THE DRAWINGS

Features and advantages of some embodiments, and the manner in which the same are accomplished, will become more readily apparent with reference to the following detailed description taken in conjunction with the accompanying drawings, which illustrate exemplary embodiments, wherein:

FIG. 1 is a block diagram illustrating a payment card account system.

FIG. 2 is a block diagram of an embodiment of an ACH system.

FIG. 3 is a diagram that illustrates a financial transaction system provided according to aspects of this disclosure.

FIG. 4 is a block diagram illustrating a computer system that may perform functions in the system of FIG. 3 in accordance with some aspects of the disclosure.

FIG. 5 is a flow chart that illustrate a process that may be performed in the system of FIG. 3 in accordance with some aspects of the disclosure.

FIG. 6 is a block diagram that schematically illustrates a transaction performed according to aspects of the process of FIG. 5.

### DETAILED DESCRIPTION

In general, and for the purpose of introducing concepts of novel embodiments described herein, a transaction routing selection system may serve as a sole point of contact between ODFIs and a number of different payment transaction routing systems. The payment transaction routing systems may include one or more ACH systems and one or more payment card networks. When a payment transaction request message is received by the transaction routing selection system, it may select among the various transaction routing systems based on one or more rules applied to characteristics of the transaction, of the originating and receiving FIs, and of the payment transaction routing systems. The characteristics may include the country of origin of the transaction, the destination country, a deadline for completion of the transaction, membership of the ODFI or RDFI (receiving depository FI) in routing systems and the transaction costs associated with the respective transaction routing systems.

With a transaction routing selection system as described herein, an ODFI may have access to a number of different transaction routing systems via a single point of contact with the transaction routing selection system. At the same time, the transaction routing selection system may automatically select an optimal transaction routing system based on rules defined ahead of time by the ODFI in question.

Throughout this disclosure, examples of financial transactions will be described, which are not to be taken as limiting. In addition, a number of terms will be used, the use of which terms is not intended to be limiting, but rather the terms are used for convenience and ease of exposition. For example, as used herein, the term “user” may be used interchangeably with the term “consumer” and/or the with the term “cardholder” and these terms are used herein to refer to a person, individual, consumer, customer, company, business or other entity that owns (or is authorized to use) a financial account such as a bank account (i.e., a savings account and/or a checking account) or payment card account (i.e., a credit card account, debit card account, or pre-paid card account) or some other type of financial account (such as a brokerage account, loyalty card account, and/or mass transit access account). In addition, the term “payment card account” may include a credit card account, a debit card account, and/or a deposit account or other type of financial account that an account holder or cardholder may access. The term “payment card account number” includes a number that identifies a payment card system account or a number carried by a payment card, and/or a number that is used to route a transaction in a payment system that handles debit card and/or credit card transactions and the like. Moreover, as used herein the terms “payment card system” or “payment card account system” refer to a system and/or network for processing and/or handling purchase transactions and related transactions, which may be operated by a payment card system operator such as Mastercard International Incorporated (the assignee hereof), or a similar system. In some embodiments, the term “payment card system” may be limited to systems in which member financial institutions (such as banks) issue payment card accounts to individuals, businesses and/or other entities or organizations (and thus are known as issuer financial institutions or issuer banks). In addition, the terms “payment card system transaction data” and/or “payment card network transaction data” or “payment card transaction data” refer to transaction data associated with payment or purchase transactions that have been or are being processed over and/or by a payment card network or payment card account system. For example, payment card system transaction data may include a number of data records associated with individual payment transactions (or purchase transactions) of cardholders that have been processed over a payment card system or payment card network. In some embodiments, payment card system transaction data may include information such as data that identifies a cardholder, data that identifies a cardholder's payment device and/or payment card account, transaction date and time data, transaction amount data, an indication of the merchandise or services that have been purchased, and information identifying a merchant and/or a merchant category. Additional transaction details and/or transaction data may also be available and/or utilized for various purposes in some embodiments.

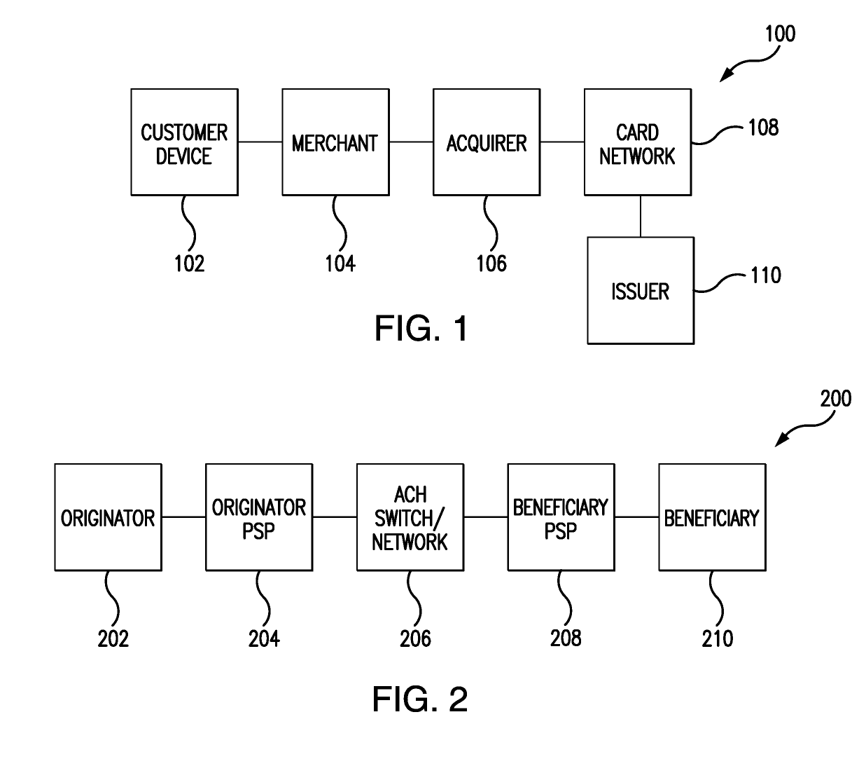

FIG. 1 is a block diagram that illustrates a payment card system 100. The payment card system 100 includes a customer device 102 such as a magnetic stripe card, a payment IC (integrated circuit) card (contactless and/or contact), or a payment-enabled mobile device (such as a smartphone that includes a payment application), a merchant device 104, an acquirer financial institution (FI) computer 106, a card network 108, and an issuer FI computer 110.

The merchant device 104 may be, for example, a POS (point of sale) terminal/card reader or a merchant mobile device (i.e., a smartphone), and may also be considered part of the payment card account system 100. The customer device 102 may be presented to the merchant device 104 to consummate a purchase transaction and to permit the merchant device 104 to read payment card account data (including, for example, a payment account number) from the customer device 102. In other situations, the merchant device 104 may be an e-commerce server computer, and the customer device 102 may be a personal computer or a mobile device running mobile browser software or the like. In this case, the customer device 102 may engage in an online shopping session with an e-commerce website hosted by the merchant device 104.

During a purchase transaction, the acquirer FI computer 106 may receive a payment account system authorization request message for the transaction from the merchant device 104. The acquirer FI computer 106 may then route the authorization request message via a card network 108 to an issuer FI computer 110, which is operated by the issuer of a payment account that is associated with the account number obtained by the merchant device 104 (e.g., from the customer device 102) and included in the authorization request message. In some implementations, the authorization response message generated by the payment issuer server computer 110 is routed back to the merchant device 104 via the card network 108 and the acquirer FI computer 106.

One well known example of a payment card network is referred to as the “Banknet” system, and is operated by Mastercard International Incorporated, the assignee of the present application.

Referring again to FIG. 1, the payment account issuer FI computer 110 may be operated by or on behalf of a financial institution, such as a bank, that issues payment accounts to individual users (such as the customer or consumer who presented or operated the customer device 102 referred to above). For example, the payment account issuer FI computer 110 may perform such functions as (a) receiving and responding to requests for authorization of payment account transactions to be charged to payment accounts issued by the FI; and (b) tracking and storing transactions and maintaining account records.

The payment card account system communications among the merchants, acquirers, card network and/or issuers may conform to a known standard such as ISO 8583.

It should be understood that the components shown in the system 100 of FIG. 1 are only those that are needed for processing a single transaction. However, a typical or practical payment system may process hundreds, thousands or more purchase transactions per day (including simultaneous transactions), and thus may include a considerable number of payment account issuers and their computers and/or computer networks, a considerable number of acquirers and their computers and/or computer networks, and numerous merchants and their devices, as well as a very large number of customer devices.

As noted above, it has also been proposed to utilize a payment card network as the “backbone” of a remittance system. One such remittance system is disclosed in U.S. published patent application no. 2008/0249929, which is incorporated herein by reference.

FIG. 2 is a block diagram illustrating an ACH system 200. The ACH system 200 includes an originator device 202, for example, a computer operated by an originator of a transaction. Common kinds of transactions handled by the ACH system 200 include credit transactions and debit transactions, wherein the originator 202 is the party that initiates the transaction. The originator may be, for example, an individual or a corporation or other organization or entity.

Referring again to FIG. 2, the ACH system 200 also includes an originator PSP (payment services provider) computer 204. The originator PSP computer 204 receives payment instructions from the originator and forwards data entries that reflect the instructions to an ACH switch/network 206, which is also part of the ACH system 200. The originator PSP computer 204 may be operated by an originator PSP (which may be, for example, an ODFI) of which the originator is a customer. In some embodiments, the ACH switch/network 206 can be operated by a government agency or a private entity that serves as a clearing facility for the system 200.

Also included in the system 200 is a beneficiary PSP computer 208 (which may be, for example, an RDFI). The beneficiary PSP computer 208 receives entries from the ACH switch/network 206 and posts entries to accounts of depositors.

Still further, the system 200 includes a beneficiary 210 that is one of the depositors of the beneficiary PSP. In the case of a credit transaction, the account at the beneficiary PSP of the beneficiary may be credited with the amount instructed to be paid by the originator device 202. The beneficiary may be, for example, an individual or a corporation or other organization. Both the originator and beneficiary PSPs may be banks or other types of FIs.

The communications among the parties in the payment network system 200 may typically be conducted using XML (eXtensible Markup Language) and may comply with a standard according to ISO 20022.

It should be understood that the components of the system 200 as depicted in FIG. 2 are only those that are needed for processing a single transaction. However, a typical ACH system 200 may process many transactions (including simultaneous transactions) and therefore may include a considerable number of PSPs and their computers and/or computer networks, one or more clearing operators, and numerous originators and beneficiaries.

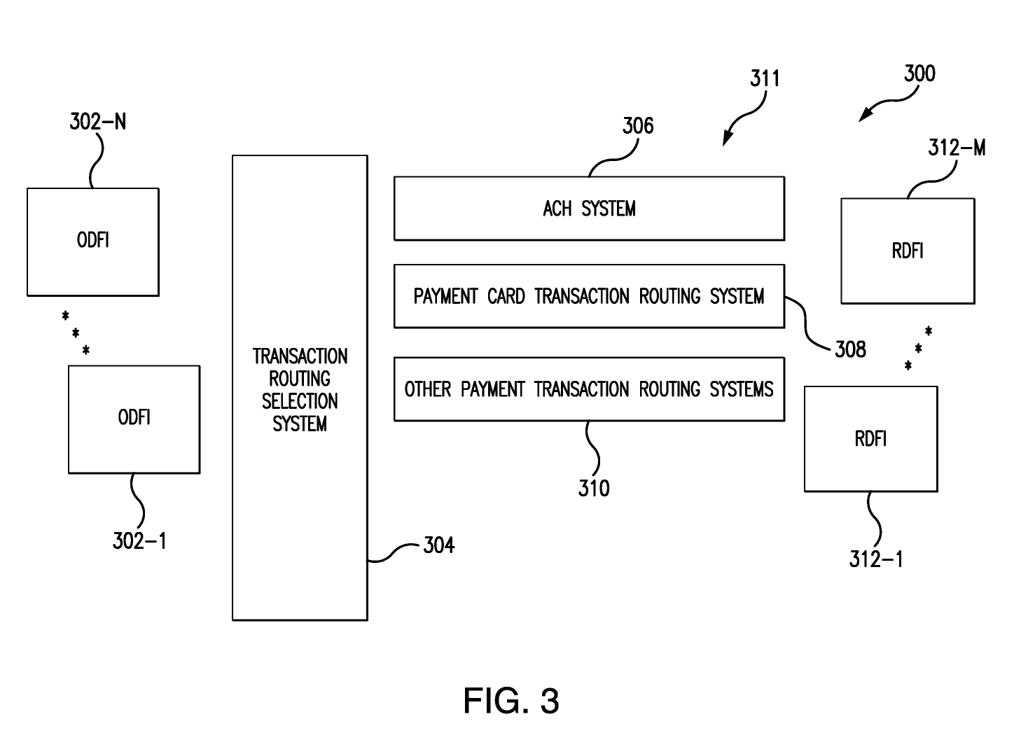

FIG. 3 is a block diagram illustrating a financial transaction system 300 in accordance with some embodiments.

The system 300 includes a number (potentially a large number) of ODFIs 302. The system 300 further includes a transaction routing selection system 304 that operates in accordance with aspects of the present disclosure. Still further, the system 300 of FIG. 3 may include an ACH system 306, a payment card transaction routing system 308 and possibly one or more other payment transaction routing systems, which are collectively represented by block 310. The ACH system 306, the payment card transaction routing system 308, and the other payment transaction routing system(s) 310 may collectively be referred to as “routing options 311”. Still further, the system 300 includes RDFIs 312. It should be noted that an FI that performs the role of an ODFI with respect to one transaction may play the role of RDFI with respect to another transaction. Accordingly, viewing the system 300 apart from its operation in connection with a particular transaction, there may be a great deal of overlap among the FIs denoted as ODFIs in the drawing and those denoted as RDFIs in the drawing.

In some embodiments, the ACH system 306 may be a batch-type system, and the other payment transaction routing systems 310 may include a so-called “fast ACH” system (not separately shown). In some embodiments, the other payment transaction routing systems 310 may include a payment card transaction routing system (not separately shown) that is operated by an entity that is different from the entity that operates the system 308.

Operation of the system 300 will be described in detail below. However, to provide a brief operational overview, in a typical transaction an ODFI 302 transmits a payment transaction request message to the transaction routing selection system 304. According to a methodology described below, the transaction routing selection system 304 selects a particular one from among the routing options 311 for execution of the requested transaction. The transaction is then executed using the selected routing option, resulting in a transfer of funds from the requesting ODFI 302 to the RDFI 312 specified in the request message. Presumably the transaction is funded by the account at the ODFI funded by the party (the transaction sender) that requested the ODFI 302 to perform the transaction, and is credited to the account of the transaction recipient at the RDFI 312 in question, with account information for the transaction recipient having been specified in the request message.

Although FIG. 3 does not explicitly show connections among the system components illustrated therein, it should be understood that data communication channels exist among the system components as required to support the messaging and transaction execution described in this disclosure. It should also be noted that each block shown in FIG. 3, in addition to representing an entity, should also be taken to represent one or more computers operated by the entity in question.

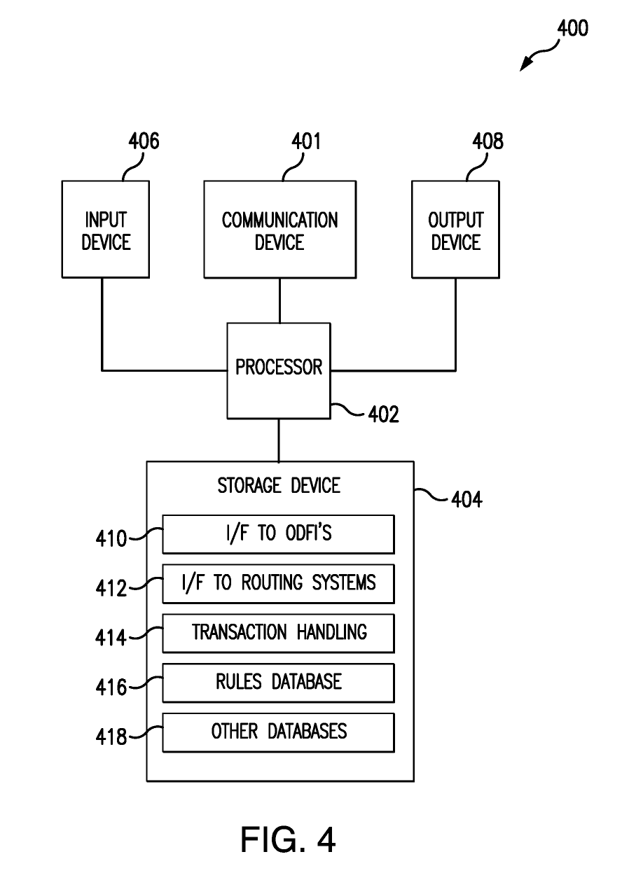

FIG. 4 is a block diagram of an example computer system 400 that may implement some or all of the functionality of the transaction routing selection system 304 (FIG. 3). As such, it may be referred to as a “routing selection computer.”

Referring then to FIG. 4, the routing selection computer 400 may, in its hardware aspects, resemble a typical server computer and/or mainframe computer, but may be controlled by software to cause it to function as described herein. In addition, the routing selection computer 400 may be designed as a special purpose computer, and thus specially configured to perform the functions described herein.

The routing selection computer 400 may include one or more processor(s) 402 operatively coupled to a communication device 401, a storage device 404, an input device 406 and an output device 408. The communications device 401, the storage device 404, the input device 406 and the output device 408 may all be in communication with and/or operably connected to the processor(s) 402. The processor(s) 402 operate to execute processor-executable steps, contained in program instructions described below, so as to control the routing selection computer 400 to provide desired functionality.

Communication device 401 may be used to facilitate communication with, for example, other devices (such as at ODFIs 302 and transaction routing systems). Communication device 401 may comprise numerous communication ports (not separately shown), to allow the routing selection computer 400 to communicate simultaneously with a number of other computers and/or other devices, including communications as required to simultaneously handle numerous interactions with other devices which may be associated with numerous transactions, and to simultaneously handle numerous translations of transactions during processing.

Input device 406 may comprise one or more of any type of peripheral device typically used to input data into a computer. For example, the input device 406 may include a keyboard and a mouse. Output device 408 may comprise, for example, a display and/or an audio speaker, and/or a printer.

Storage device 404 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as flash memory and the like. Any one or more of such information storage devices may be considered to be a non-transitory computer-readable storage medium or a computer usable medium or a memory.

Storage device 404 stores one or more programs for controlling the processor(s) 402. The programs comprise program instructions (which may be referred to as computer readable program code means) that contain processor-executable process steps of the routing selection computer 400, executed by the processor(s) 402 to cause the routing selection computer 400 to function as described herein.

The programs may include one or more conventional operating systems (not shown) that control the processor(s) 402 so as to manage and coordinate activities and sharing of resources in the routing selection computer 400, and to serve as a host for application programs (described below) that run on the routing selection computer 400.

The programs stored in the storage device 404 may include, for example, a software interface 410 to facilitate communication between the routing selection computer 400 and ODFIs 302.

Another program that may be stored in the storage device 404 is a software interface 412 to support communication between the routing selection computer 400 and the routing options 311.

The storage device 404 may also store a transaction handling application program 414. The transaction handling application program 414 may control the processor(s) 402 to enable the routing selection computer 400 to handle transaction request messages in a manner that will be described below.

The storage device 404 may also store, and the processor(s) 402 may also execute, other programs, which are not shown. For example, such programs may include communications software and one or more reporting applications. The latter program(s) may respond to requests from system administrators, for example, for reports on the activities performed by the routing selection computer 400. The other programs may also include, for example, device drivers, database management software, and the like.

In addition, the storage device 404 may store a rules database 416. The rules database may contain sets of rules that govern how the routing selection computer 400 is to make routing selection decisions with respect to particular categories of transaction requests.

The storage device 404 may also store one or more databases 418 that may be required for operation of the routing selection computer 400.

It should be understood that other computerized components of the system 300 (FIG. 3) may be constituted by computer hardware having the same types of components and/or hardware architecture as described herein with reference to FIG. 4.

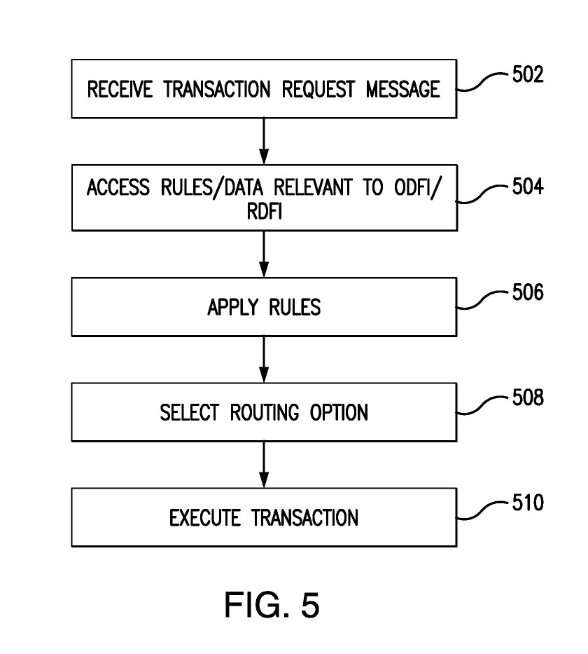

FIG. 5 is a flow chart that illustrates a process that may be performed in the system 300 of FIG. 3 in accordance with some embodiments of the disclosure. Primarily, the process of FIG. 5 may be performed by the routing selection computer 400.

At 502 in FIG. 5, the routing selection computer 400 may receive a payment transaction request message from one of the ODFIs 302. It will be appreciated that the requested transaction may have a number of attributes, which may be indicated by data contained in the transaction request message or which may be otherwise known or available for discovery by the routing selection computer 400. The attributes of the requested transaction may include the identity of the requesting ODFI and the identity of the RDFI that is to receive the requested transaction. Other attributes may include the name and account number of the remitter (i.e. the party that is initiating the transfer) and the name and account number of the recipient of the requested transaction. Still other attributes may include the country of origin for the requested transaction and the country of destination for the requested transaction. Another attribute may be the amount of the requested transaction (monetary amount to be transferred). Yet another attribute may be a deadline for completion of the transaction; that is, a date and/or time by which the transferred funds are to be available to the recipient.

Other relevant data, which may be available to the routing selection computer 400, may include the identities of the routing options in which the requesting ODFI holds membership and the identities of the routing options in which the RDFI for the transaction holds memberships. In addition, data available to the routing selection computer 400 may include what would be the respective cost of executing the transaction with each of the routing options 311.

At 504 in FIG. 5, the routing selection computer 400 may access one or more rules and/or data relevant to the ODFI and RDFI for the current data, where the rule(s) and/or data are also relevant to a routing selection decision to be made by the routing selection computer 400 for the currently requested transaction.

At 506 in FIG. 5, the routing selection computer 400 may apply the relevant rule or rules.

At 508, the routing selection computer 400 may select one of the routing options 311 for use in executing the currently requested transaction. This selection may be determined by an outcome of block 506 and may be based on one or more of the following: (a) country of origin of the requested transaction; (b) destination country of the requested transaction; (c) a deadline for completion of the requested transaction; (d) which of the routing options 311 the ODFI and the RDFI hold memberships in; (e) respective transaction costs associated with the transaction routing options; and (0 which of the routing options are configured to transmit appended data. In applying one or more relevant rules and making the selection among the routing options, the routing selection computer 400 may first set aside any of the routing options which either the ODFI or the RDFI does not have membership in. Among the remaining routing options, the routing selection computer 400 may select the lowest cost routing option that will complete the transaction in accordance with any applicable deadline for completion. Other types of rules may alternatively be applied, such as a preference by the ODFI for a certain one or ones of the routing options 311.

At 510, the routing selection computer 400 may cause the requested transaction to be executed via the routing option selected at 508. If necessary, this may involve the routing selection computer 400 translating the transaction request into the appropriate format and/or protocol supported by the selected routing option. In performing required translation, the routing selection computer 400 may rely on one or more data libraries or data dictionaries that are accessible to the routing selection computer 400.

The execution of the transaction may also involve the routing selection computer 400 arranging for provision of one or more value-added services with respect to the transaction. Such value-added services may include fraud and/or anti-money laundering (AML) checks.

In dispatching the transaction via the selected routing option, the routing selection computer 400 may take necessary actions to comply with the rules applicable to execution of transactions via the selected routing option. Dispatching the transaction for execution by the selected routing option may include transmitting a suitable transaction request message by the routing selection computer 400 to a gateway associated with the selected routing option.

In some cases, the request message received by the routing selection computer 400 at 502 may specify a particular routing option to be used, in which case the routing selection computer 400 will execute the transaction via the specified routing option.

Format/protocol translation may also occur at the RDFI side of the transaction.

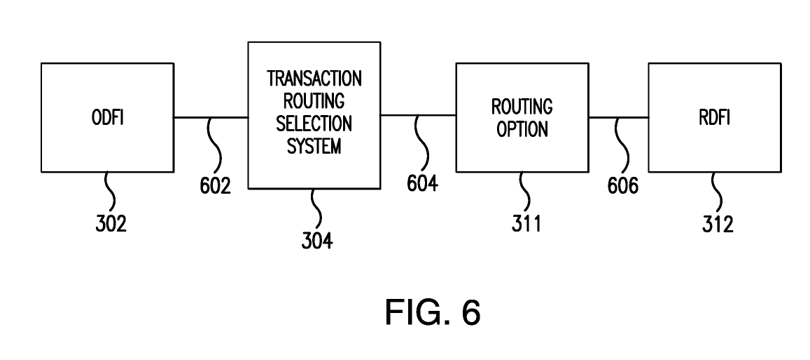

FIG. 6 is a block diagram that schematically illustrates a transaction performed according to aspects of the process of FIG. 5.

FIG. 6 shows components of the system 300 of FIG. 3, including an ODFI 302, the transaction routing selection system 304, a routing option 311 and an RDFI 312. Also shown in FIG. 6 are an electronic data communication channel 602, by which messaging occurs from the ODFI 302 to the transaction routing selection system 304; an electronic data communication channel 604, by which messaging occurs from the transaction routing selection system 304 to the routing option 311; and an electronic data communication channel 606 by which messaging occurs from the routing option 311 to the RDFI 312.

A transaction routing selection system as described herein may provide ODFIs with convenient access to a number of different transaction routing systems via a single point of contact, with (if desired by the ODFI) automatic selection at the routing selection computer of an optimal one of the available transaction routing systems. This may save the ODFIs from costs and efforts required to maintain separate points of contact with each transaction routing system to which a particular ODFI belongs, while also relieving ODFIs from the burden of integrating their communications and computing resources with multiple transaction routing systems.

The above descriptions and illustrations of processes herein should not be considered to imply a fixed order for performing the process steps. Rather, the process steps may be performed in any order that is practicable, including the omission of one or more steps and/or the simultaneous performance of at least some steps.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

Although the present invention has been described in connection with specific exemplary embodiments, it should be understood that various changes, substitutions, and alterations would be apparent to those skilled in the art and can be made to the disclosed embodiments without departing from the spirit and scope of the invention as set forth in the appended claims.

What is claimed is:

1. A method comprising:
receiving a request for a payment transaction from an originating depository financial institution (ODFI) acting on behalf of a remitter, the requested payment transaction having a plurality of attributes;
based at least in part on said attributes of said requested payment transaction, selecting one transaction routing option from among a plurality of transaction routing options, said plurality of transaction routing options including at least one ACH (automated clearing house) transaction routing system and at least one payment card account system; and
executing the requested payment transaction via the selected one transaction routing option.

2. The method of claim 1, wherein the attributes of the requested payment transaction include country of origin, country of destination, and a deadline for completion of the payment transaction.

3. The method of claim 2, wherein said selecting is also based in part on respective transaction costs associated with the transaction routing options.

4. The method of claim 3, wherein the selecting is also based in part on whether an originating financial institution (FI) holds membership in ones of the plurality of transaction routing options.

5. The method of claim 3, wherein the selecting is also based in part on whether a receiving financial institution (FI) holds membership in ones of the plurality of transaction routing options.

6. The method of claim 1, wherein the executing step includes translating a format of the requested payment transaction to a format suitable for the selected one of the transaction routing options.

7. The method of claim 1, wherein the executing step includes adapting the requested payment transaction to a protocol required for the selected one of the transaction routing options.

8. The method of claim 1, wherein said at least one ACH system includes at least two ACH systems.

9. The method of claim 8, wherein said at least one payment card account system includes at least two payment card account systems.

10. A method comprising:
receiving a request for a payment transaction;
selecting one transaction routing option from among a plurality of transaction routing options, said plurality of transaction routing options including one or more ACH (automated clearing house) transaction routing systems and one or more payment card account systems; said selecting based on at least two of (a) country of origin of the payment transaction; (b) destination country of the payment transaction; (c) a deadline for completion of the requested payment transaction; (d) whether an originating financial institution (FI) holds membership in ones of the plurality of transaction routing options; (e) whether a destination FI holds membership in ones of the plurality of transaction routing options; (0 respective transaction costs associated with the transaction routing options; and (g) a capability of a transaction routing option to transmit appended data; and
executing the requested payment transaction via the selected one transaction routing option.

11. The method of claim 10, wherein said selecting is based on all of (a) country of origin of the payment transaction; (b) destination country of the payment transaction; (c) a deadline for completion of the requested payment transaction; (d) whether an originating financial institution (FI) holds membership in ones of the plurality of transaction routing options; (e) whether a destination FI holds membership in ones of the plurality of transaction routing options; (f) respective transaction costs associated with the transaction routing options; and (g) a capability of a transaction routing option to transmit appended data.

12. The method of claim 10, wherein the executing step includes translating a format of the requested payment transaction to a format suitable for the selected one of the transaction routing options.

13. The method of claim 10, wherein the executing step includes adapting the requested payment transaction to a protocol required for the selected one of the transaction routing options.

14. An apparatus comprising:
a processor; and
a memory in communication with the processor, the memory storing program instructions, the processor operative with the program instructions to perform functions as follows:
receiving a request for a payment transaction from an originating depository financial institution (ODFI) acting on behalf of a remitter, the requested payment transaction having a plurality of attributes;
based at least in part on said attributes of said requested payment transaction, selecting one transaction routing option from among a plurality of transaction routing options, said plurality of transaction routing options including at least one ACH (automated clearing house) transaction routing system and at least one payment card account system; and
executing the requested payment transaction via the selected one transaction routing option.

15. The apparatus of claim 14, wherein the attributes of the requested payment transaction include country of origin, country of destination, and a deadline for completion of the payment transaction.

16. The apparatus of claim 15, wherein said selecting is also based in part on respective transaction costs associated with the transaction routing options.

17. The apparatus of claim 16, wherein the selecting is also based in part on whether an originating financial institution (FI) holds membership in ones of the plurality of transaction routing options.

18. The apparatus of claim 16, wherein the selecting is also based in part on whether a receiving financial institution (FI) holds membership in ones of the plurality of transaction routing options.

19. The apparatus of claim 14, wherein the executing function includes translating a format of the requested payment transaction to a format suitable for the selected one of the transaction routing options.

20. The apparatus of claim 14, wherein the executing function includes adapting the requested payment transaction to a protocol required for the selected one of the transaction routing options.
